(19) United States
(12) Patent Application Publication
(10) Pub. No.: US 2023/0087386 A1
(43) Pub. Date: Mar. 23, 2023

(54) SYSTEM AND METHOD FOR A SUPPORT CLIP TO ATTACH A DECORATIVE ELEMENT

(71) Applicant: Simple Living Solutions, LLC, Scottsdale, AZ (US)

(72) Inventor: Jamie Limber, Phoenix, AZ (US)

(73) Assignee: Simple Living Solutions, LLC, Scottsdale, AZ (US)

(21) Appl. No.: 18/071,871

(22) Filed: Nov. 30, 2022

Related U.S. Application Data
(63) Continuation-in-part of application No. 29/747,918, filed on Aug. 26, 2020.

(51) Int. Cl. F21V 21/088; F16M 13/02

(52) U.S. Cl. CPC F21V 21/088; F16M 13/022

(57) ABSTRACT

Disclosed is a support clip that may be affixed to a variety of surfaces and objects and able to support a decoration. The support clip generally comprises two coiled ends connected by an arcuate body portion, with a support hook extending from the body portion. The coiled ends may include textured surfaces such as a plurality of ridges to improve grip and prevent the support clip from decoupling when the weight of a decoration is added. A variety of types, quantities, and orientations of support hooks are used in different embodiments of the support clip to enable a user to hang multiple or different types of decorations. The support clip is configured such that the flexural rigidity of any appropriate material causes the structure to couple in a vise-like manner to a variety of surfaces, for example the mantel of a fireplace, without additional fasteners.

### CROSS REFERENCE TO RELATED APPLICATIONS

This application is a continuation in part of application Ser. No. 29/747,918 entitled “Bannister—Mantel Clip for Supporting Holiday Ornamental Decorative Elements” to Jamie Limber filed on Aug. 26, 2020.

### BACKGROUND

### 1. Field of the Invention

This disclosure generally relates to articles used for securing holiday decorations, and relates more particularly to a clip that secures to a variety of surfaces, wherein the clip aids to support decorations, such as lights, ornaments, wreaths, garland, stockings, and others.

### 2. Description of Related Art

Holiday decorating can be a cumbersome task, and securing seasonal decorating items can often be problematic. In many instances, users rely upon nails, screws, tabs, sticky hooks, tape and other securing mechanisms to secure their holiday decorative items. Decorative items, such as lights, ornaments, wreaths, stockings, garland, etc., are routinely secured to various home fixtures, such as bannisters, railings, fireplace mantels, shelves, and the like using such securing mechanisms; however, these types of securing mechanisms may often damage or mar the surfaces to which they are affixed, or require specific tools to affix and remove.

### SUMMARY

The present invention provides among other things a system and method for affixing decorations to various surfaces via a removable support clip.

Implementations of a support clip may comprise a first coiled end, an arcuate body portion extending from the first coiled end, and a second coiled end extending from a point on the arcuate body portion that is distal from the first coiled end, with the second coiled end positioned at a point proximal to the first coiled end. Further, one or more support hooks are positioned along the arcuate body portion between the first coiled end and the second coiled end, and extend outwardly from the arcuate body portion.

Particular aspects of a support clip may include embodiments wherein the one or more support hooks extend outwardly from the arcuate body portion in a direction distal from the first coiled end and the second coiled end. They may also include embodiments wherein the one or more support hooks extend outwardly from the arcuate body portion in substantially the same direction as the first coiled end and second coiled end. Particular aspects may further include an embodiment wherein the one or more support hooks are formed of one or more substantially linear segments. Additionally, the one or more support hooks may instead be specifically two or more support hooks. In some embodiments the arcuate body portion, the first coiled end, and the second coiled end are substantially co-planar.

Another implementation of a support clip may comprise a first coiled end comprising a textured surface, an arcuate body portion extending from the first coiled end, and a second coiled end extending from a point on the arcuate body portion that is distal from the first coiled end, with the second coiled end positioned at a point proximal to the first coiled end. Additionally, one or more support hooks are positioned along the arcuate body portion between the first coiled end and the second coiled end, and extending outwardly from the arcuate body portion.

Particular aspects of this implementation may include an embodiment wherein the textured surface comprises a plurality of ridges. Additionally, the second coiled end may further comprise a textured surface. An embodiment of this implementation may also be one where the one or more support hooks comprises two or more support hooks. Another embodiment may be one where the arcuate body portion, the first coiled end, and the second coiled end are substantially co-planar. In the embodiment where the second coiled end also comprises a textured surface the arcuate body portion, the first coiled end, and the second coiled end may also be substantially co-planar. In some embodiments the one or more support hooks may extend outwardly from the arcuate body portion in a direction distal to the first coiled end and the second coiled end. In other embodiments the support hook may extend outwardly from the arcuate body portion in substantially the same direction as the first coiled end and second coiled end.

An implementation for producing a support clip includes forming a support clip by forming a first coiled end, an arcuate body portion extending from the first coiled end, a second coiled end extending from a point on the arcuate body portion that is distal to the first coiled end, with the second coiled end positioned at a point proximal to the first coiled end, and one or more support hooks positioned along the arcuate body portion between the first coiled end and the second coiled end, and extending outwardly from the arcuate body portion.

Particular variants of this implementation may include an embodiment wherein at least one of the first coiled end or the second coiled end further comprises a textured surface. Another embodiment may be one wherein the arcuate body portion, the first coiled end, and the second coiled end are substantially co-planar. A variation on the embodiment with textured surfaces may also be one wherein the arcuate body portion, the first coiled end, and the second coiled end are substantially co-planar. Additionally, a support clip may be made with one or more support hooks extending outwardly from the arcuate body portion in a direction distal to the first coiled end and the second coiled end. Lastly, a support clip may be made wherein the support hook extends outwardly from the arcuate body portion in substantially the same direction as the first coiled end and second coiled end.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographer, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or Claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for,” and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION, DRAWINGS, and CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a perspective view of an embodiment of a support clip;

FIG. 2 depicts a side view of the embodiment of the support clip;

FIG. 3 depicts an exemplary use of the embodiment of the support clip; and

FIGS. 4A-4D depicts various alternate embodiments of support clip articles.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

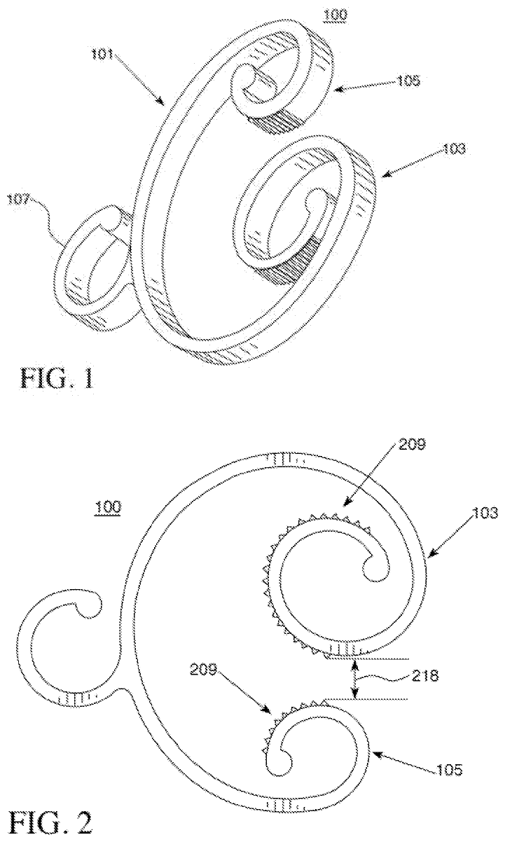

In one application, the present invention comprises a support clip for hanging one or more decorative elements. Referring now to FIG. 1, an exemplary embodiment of a support clip 100 is shown. In many embodiments, the support clip 100 comprises a first coiled end 103, an arcuate body portion 101 extending from the first coiled end 103, a second coiled end 105 extending from the arcuate body portion 101, and one or more support hooks 107 positioned along the arcuate body portion 101 between the first coiled end 103 and the second coiled end 105. In some embodiments, the second coiled end 105 extends from the arcuate body portion 101 into a position proximal to the first coiled end 103 such that the first coiled end 103 and second coiled end 105 are coiled inward toward an interior of the arcuate body portion 101. This allows the first coiled end 103 and second coiled end 105 to grip a surface such as a banister or mantel while also holding and securing one or more decorative elements such as by non-limiting example, a strand of decorative lighting or a holiday decoration within the one or more support hooks 107. Additionally in some embodiments the one or more support hooks 107 extend outwardly from the arcuate body portion 101. In these and other embodiments the first coiled end 103 and the second coiled end 105 have a coiled or spiral shape. It will be understood by those having ordinary skill that a coiled end may comprise tighter or looser spirals, non-regular spirals, or many other variations of the spiral shown here while adhering to the spirit of the invention. In many embodiments, the arcuate body portion 101 may have a C-shape as is shown here, however it will be understood by those skilled in the art that a variety of degrees of curvature may be used to achieve various embodiments of the present invention. In some embodiments, the first coiled end 103 and the second coiled end 105 are substantially co-planar with the arcuate body portion 101, such that the first coiled end 120 and the second coiled end 122 are separate and aligned in proximity to one another.

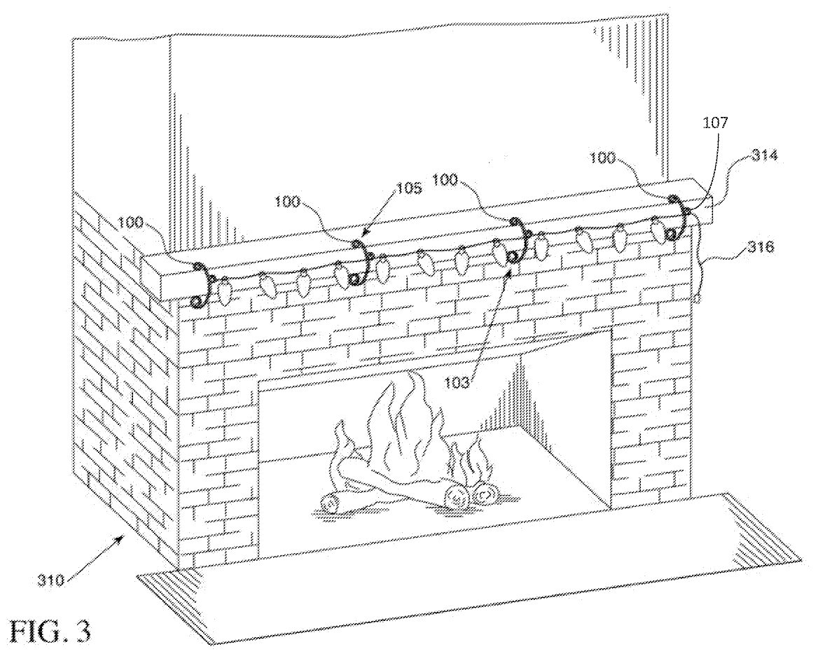

Referring now to FIG. 2, a side view of an exemplary embodiment of a support clip 100 is shown. In embodiments wherein the first coiled end 103 and second coiled end 105 are substantially co-planar, they may still be separated by a gap 218. This gap may be a variety of sizes in different embodiments, and is configured to accommodate a part of a fixed object such as a structure, fixture, pole, or other object such that the support clip 100 becomes removably affixed to the fixed object. In many embodiments, the support clip 100 may be comprised of a variety of different materials such as plastics, wood, metal, or any other materials having an appropriate flexural rigidity to keep the support clip 100 affixed to the fixed object. In these and other embodiments, at least one of the first coiled end 103 and the second coiled end 105 may comprise a textured surface 209 comprising one or more nubs, teeth, ridges, or roughly textured materials to enhance the ability of the support clip 100 to grip and remain attached to a fixed object.

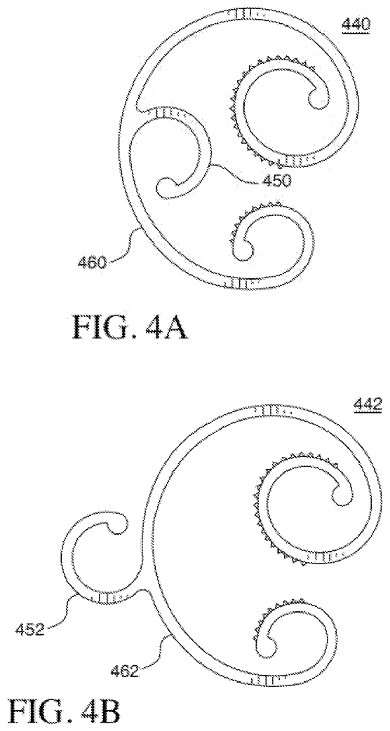

Referring now to FIG. 3, an exemplary embodiment of multiple support clips 100 in use is shown. An example of a fixed object as discussed above may include a fixture such as a fireplace 310 having a mantel 314. In these and similar embodiments, a support clip 100 may be affixed to a mantel 314 by bending the support clip 100 such that the first coiled end 103 presses into the bottom of the mantel 314 and the second coiled end 105 presses into the top of the mantel 314. In many embodiments, by stretching the clip in this manner the flexural rigidity of the material creates a force resisting the deformation of the support clip 100, thus compressing the first coiled end 103 and the second coiled end 105 against the mantel 314. In these and other embodiments a decoration 316 can then be strung through the support hook 107 of the support clip 100, allowing the decoration to hang from the mantel 314.

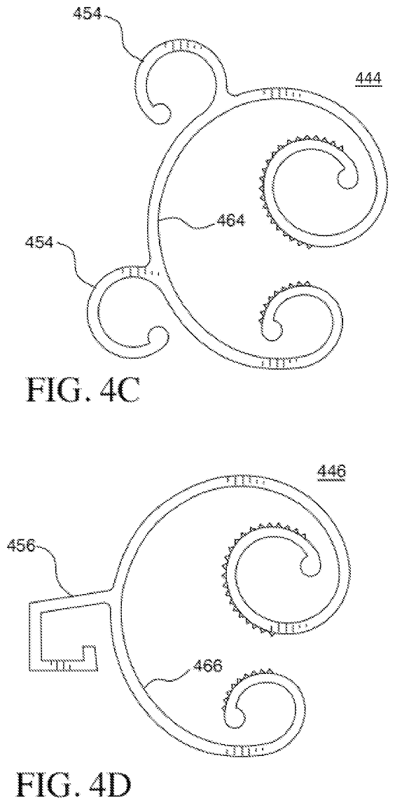

In FIG. 1, an embodiment of a support hook 107 is shown, however a variety of positions, orientations, and quantities of support hooks may readily be used for the present invention. Referring now to FIG. 4A-D, several exemplary embodiments of a support clip are shown. In FIG. 4A, an exemplary embodiment of a support clip 440 is shown having a support hook 450 extending outward from the arcuate body portion 460 internal to the curvature of the arcuate body portion 460 and toward the coiled ends 103, 105 of the support clip 100. In some embodiments, it may be desirable to have the support hook 450 closer to or further from the coiled ends for attaching the support clip 440 to different fixed objects while accommodating certain types of decorations. In FIG. 4B, an exemplary embodiment of a support clip 442 is shown having a support hook 452 extending outwardly from the arcuate body portion 462 external to the curvature of the arcuate body portion 462 and distal from the coiled ends. In these and other embodiments, the support clip 442 may be constructed such that the support hook 452 is oriented in any of a variety of directions to accommodate various decorations.

Referring now to FIG. 4C, an exemplary embodiment of a support clip 444 is shown having two support hooks 454. It may be understood that in these and other embodiments different numbers of support hooks 454 may be used along the arcuate body portion 464, resulting in various numbers of support hooks 454.

Referring now to FIG. 4D, an exemplary embodiment of a support clip 446 is shown with a support hook 456 comprised of linear segments as opposed to the curved examples shown previously. It may be understood by a person of ordinary skill that a support hook 456 and other support hooks shown may be formed of one or more linear segments to create a hook structure suitable for hanging a decoration. In the exemplary embodiment of the support hook 456, it can be seen that the support hook 456 is comprised of four substantially linear segments forming a nearly quadrilateral structure. However, in many embodiments a variety of other numbers of substantially linear segments may be used to form a support hook 456.

Any and all of the above embodiments of a support clip may be produced by a variety of methods as long as each of the component parts of the support clip are formed. For example, the support clip may be formed from one piece, such as by injection molding, or from multiple segments that have been coupled together. A person having ordinary skill in the art using ordinary methods may form a support clip using any appropriate materials as long as the support clip has a first coiled end, an arcuate body portion extending from the first coiled end, a second coiled end extending from a point on the arcuate body portion that is distal to the first coiled end, with the second coiled end positioned at a point proximal to the first coiled end, and one or more support hooks positioned along the arcuate body portion between the first coiled end and the second coiled end, and extending outwardly from the arcuate body portion. In many embodiments a textured surface may also be formed on at least one of the first coiled end and second coiled ends.

In places where the description above refers to particular implementations of systems and methods for a support clip to attach a decorative element, it should be readily apparent that a number of modifications may be made without departing from the spirit thereof and that these implementations may be applied to other systems and methods for a support clip to attach a decorative element.

I claim:

1. A support clip comprising:
a first coiled end;
an arcuate body portion extending from the first coiled end;
a second coiled end extending from a point on the arcuate body portion that is distal from the first coiled end, with the second coiled end positioned at a point proximal to the first coiled end; and
one or more support hooks positioned along the arcuate body portion between the first coiled end and the second coiled end, and extending outwardly from the arcuate body portion.

2. The support clip of claim 1, wherein the one or more support hooks extend outwardly from the arcuate body portion in a direction distal from the first coiled end and the second coiled end.

3. The support clip of claim 1, wherein the one or more support hooks extends outwardly from the arcuate body portion in substantially the same direction as the first coiled end and second coiled end.

4. The support clip of claim 1, wherein the one or more support hooks are formed of one or more substantially linear segments.

5. The support clip of claim 1, wherein the one or more support hooks comprises two or more support hooks.

6. The support clip of claim 1, wherein the arcuate body portion, the first coiled end, and the second coiled end are substantially co-planar.

7. A support clip comprising:
a first coiled end comprising a textured surface;
an arcuate body portion extending from the first coiled end;
a second coiled end extending from a point on the arcuate body portion that is distal from the first coiled end, with the second coiled end positioned at a point proximal to the first coiled end; and
one or more support hooks positioned along the arcuate body portion between the first coiled end and the second coiled end, and extending outwardly from the arcuate body portion.

8. The support clip of claim 7, wherein the textured surface comprises a plurality of ridges.

9. The support clip of claim 7, wherein the second coiled end further comprises a textured surface.

10. The support clip of claim 7, wherein the one or more support hooks comprises two or more support hooks.

11. The support clip of claim 7, wherein the arcuate body portion, the first coiled end, and the second coiled end are substantially co-planar.

12. The support clip of claim 9, wherein the arcuate body portion, the first coiled end, and the second coiled end are substantially co-planar.

13. The support clip of claim 7, wherein the one or more support hooks extend outwardly from the arcuate body portion in a direction distal from the first coiled end and the second coiled end.

14. The support clip of claim 7, wherein the support hook extends outwardly from the arcuate body portion in substantially the same direction as the first coiled end and second coiled end.

15. A method for manufacturing a support clip comprising:
forming a support clip comprising:
a first coiled end;
an arcuate body portion extending from the first coiled end;
a second coiled end extending from a point on the arcuate body portion that is distal from the first coiled end, with the second coiled end positioned at a point proximal to the first coiled end; and
one or more support hooks positioned along the arcuate body portion between the first coiled end and the second coiled end, and extending outwardly from the arcuate body portion.

16. The method of claim 15, wherein at least one of the first coiled end and the second coiled end further comprises a textured surface.

17. The method of claim 15, wherein the arcuate body portion, the first coiled end, and the second coiled end are substantially co-planar.

18. The method of claim 16, wherein the arcuate body portion, the first coiled end, and the second coiled end are substantially co-planar.

19. The method of claim 15, wherein the one or more support hooks extend outwardly from the arcuate body portion in a direction distal from the first coiled end and the second coiled end.

20. The support clip of claim 15, wherein the support hook extends outwardly from the arcuate body portion in substantially a same direction as the first coiled end and second coiled end.
